(19) United States
(12) Patent Application Publication
(10) Pub. No.: US 2002/0141737 A1
(43) Pub. Date: Oct. 3, 2002

(54) Audio data recording medium and related apparatuses

(76) Inventor: Norihiko Fuchigami, Kamakura-shi (JP)

Correspondence Address: LOUIS WOO, LAW OFFICE OF LOUIS WOO, 1901 NORTH FORT MYER DRIVE, SUITE 501, ARLINGTON, VA, 22209, US

(21) Appl. No.: 10/096,248

(22) Filed: Mar. 13, 2002

(30) Foreign Application Priority Data
Mar. 27, 2001 (JP) 2001-91324
Jan. 18, 2002 (JP) 2002-9608

(51) Int. Cl. H04N 5/781

(52) U.S. Cl. 386/98; 386/125

(57) ABSTRACT

An audio-information recording medium has a data structure including a first elementary stream resulting from encoding audio data; first digital right information about the audio data; added data related to the audio data; audio objects resulting from packeting one of (1) linear PCM audio data being expansion of the first elementary stream and (2) a second elementary stream being compression of the linear PCM audio data; second digital right information related to the audio objects and generated on the basis of the first digital right information; and playback management data related to the audio objects and generated on the basis of the added data.

### BACKGROUND OF THE INVENTION

1. Field of the Invention

This invention relates to a recording medium such as an optical disc, an SD memory card, or a digi-card. Also, this invention relates to an audio-information recording apparatus, an audio-information reproducing apparatus, and an audio-information recording and reproducing apparatus. Furthermore, this invention relates to a computer program related to the recording of audio information, and a computer program related to the reproduction of audio information. In addition, this invention relates to a method of transmitting or receiving a computer program. Also, this invention relates to a reproducing apparatus comprising first means for reproducing information from a recording medium and second means for decoding a signal in the reproduced information which represents at least one still picture. Furthermore, this invention relates to a method of transmitting or receiving data recorded according to a computer program. In addition, this invention relates to a method of transmitting or receiving data reproduced according to a computer program.

2. Description of the Related Art

There are DVD-RW discs and DVD-RAM discs. The VIDEO RECORDING standards (DVD-VR standards) prescribe the format of recording video data on a DVD-RW disc or a DVD-RAM disc.

According to the DVD-VR standards, video data are recorded on a disc as video objects (VOBs). The disc is also loaded with original management data and user defined management data. The original management data represent an original PGC (program chain) used for sequentially reproducing VOBs from the disc in an order equal to that of the recording of the VOBs on the disc. The user defined management data represent a user defined PGC or PGCs. Each user defined PGC relates to ones among the VOBs and portions of the VOBs which are selected by a user. The user defined PGC is used for sequentially reproducing the selected VOBs and the selected portions of the VOBs in an order desired by the user. On each disc, there is only one original PGC and one or more user defined PGCs.

The DVD-VR standards are unsuited for the recording of only audio data on a disc. According to the DVD-VR standards, it is mandatory that each VOB contains a video stream. Thus, it is difficult to record only audio data on a disc.

Electronic music distribution (EMD) systems are provided on the Internet. Audio data can be downloaded into personal computers from the EMD systems via the Internet. The personal computers can store the downloaded audio data into recording mediums such as memory cards.

### SUMMARY OF THE INVENTION

It is a first object of this invention to provide a recording medium for storing EMD audio data which is excellent in protection of the copyright on the contents of the audio data and adaptability to various types of EMD encoding.

It is a second object of this invention to provide an apparatus for recording EMD audio data on a recording medium which is excellent in protection of the copyright on the contents of the audio data and adaptability to various types of EMD encoding. It is a third object of this invention to provide an apparatus for reproducing EMD audio data from a recording medium which is excellent in protection of the copyright on the contents of the audio data and adaptability to various types of EMD encoding.

It is a fourth object of this invention to provide an apparatus for recording and reproducing EMD audio data on and from a recording medium which is excellent in protection of the copyright on the contents of the audio data and adaptability to various types of EMD encoding.

It is a fifth object of this invention to provide a computer program related to the recording of EMD audio data on a recording medium which is excellent in protection of the copyright on the contents of the audio data and adaptability to various types of EMD encoding.

It is a sixth object of this invention to provide a computer program related to the reproduction of EMD audio data from a recording medium which is excellent in protection of the copyright on the contents of the audio data and adaptability to various types of EMD encoding.

It is a seventh object of this invention to provide an improved method of transmitting or receiving a computer program.

It is an eighth object of this invention to provide an improved reproducing apparatus comprising first means for reproducing information from a recording medium and second means for decoding a signal in the reproduced information which represents at least one still picture.

It is a ninth object of this invention to provide an improved method of transmitting or receiving data recorded according to a computer program.

It is a tenth object of this invention to provide an improved method of transmitting or receiving data reproduced according to a computer program.

A first aspect of this invention provides an audio-information recording medium having a data structure including a first elementary stream resulting from encoding audio data; first digital right information about the audio data; added data related to the audio data; audio objects resulting from packeting one of (1) linear PCM audio data being expansion of the first elementary stream and (2) a second elementary stream being compression of the linear PCM audio data; second digital right information related to the audio objects and generated on the basis of the first digital right information; and playback management data related to the audio objects and generated on the basis of the added data.

A second aspect of this invention is based on the first aspect thereof, and provides an audio-information recording medium wherein the first elementary stream and the audio objects are encrypted.

A third aspect of this invention is based on the first aspect thereof, and provides an audio-information recording medium wherein the first elementary stream and the audio objects are in a same file.

A fourth aspect of this invention provides an audio-information recording medium having a data structure including audio objects resulting from packeting a first elementary stream being compression of audio data; first digital right information about the audio data; added data related to the audio data; second digital right information related to the audio objects and generated on the basis of the first digital right information; and playback management data related to the audio objects and generated on the basis of the added data.

A fifth aspect of this invention provides a recording apparatus comprising first means for recording a first elementary stream, first digital right information, and added data on a recording medium, the first elementary stream resulting from encoding audio data, the first digital right information being about the audio data, the added data being related to the audio data; second means for expanding the first elementary stream into linear PCM audio data; third means for compressing the linear PCM audio data into a second elementary stream; fourth means for packeting one of (1) the linear PCM audio data and (2) the second elementary stream into audio objects; fifth means for generating second digital right information on the basis of the first digital right information, the second digital right information being related to the audio objects; sixth means for generating playback management data on the basis of the added data, the playback management data being related to the audio objects; and seventh means for recording the audio objects, the second digital right information, and the playback management data on the recording medium. A sixth aspect of this invention provides a recording apparatus comprising first means for packeting a first elementary stream into audio objects, the first elementary stream being compression of audio data; second means for generating, on the basis of first digital right information about the audio data, second digital right information related to the audio objects; third means for generating playback management data on the basis of added data, the playback management data being related to the audio objects, the added data being related to the audio data; and fourth means for recording the first digital right information, the added data, the audio objects, the second digital right information, and the playback management data on a recording medium.

A seventh aspect of this invention is based on the fifth aspect thereof, and provides a recording apparatus further comprising means for receiving the first elementary stream, the first digital right information, and the added data from an electronic music distribution system.

An eighth aspect of this invention provides a computer program comprising the steps of recording a first elementary stream, first digital right information, and added data on a recording medium, the first elementary stream resulting from encoding audio data, the first digital right information being about the audio data, the added data being related to the audio data; expanding the first elementary stream into linear PCM audio data; compressing the linear PCM audio data into a second elementary stream; packeting one of (1) the linear PCM audio data and (2) the second elementary stream into audio objects; generating second digital right information on the basis of the first digital right information, the second digital right information being related to the audio objects; generating playback management data on the basis of the added data, the playback management data being related to the audio objects; and recording the audio objects, the second digital right information, and the playback management data on the recording medium.

A ninth aspect of this invention provides a computer program comprising the steps of packeting a first elementary stream into audio objects, the first elementary stream being compression of audio data; generating, on the basis of first digital right information about the audio data, second digital right information related to the audio objects; generating playback management data on the basis of added data, the playback management data being related to the audio objects, the added data being related to the audio data; and

recording the first digital right information, the added data, the audio objects, the second digital right information, and the playback management data on a recording medium.

A tenth aspect of this invention is based on the eighth aspect thereof, and provides a computer program further comprising the step of receiving the first elementary stream, the first digital right information, and the added data from an electronic music distribution system.

An eleventh aspect of this invention provides a reproducing apparatus comprising first means for reading out the second digital right information and the playback management data from the audio-information recording medium of the first aspect of this invention; and second means for reproducing the audio objects from. the audio-information recording medium and playing back the audio objects in accordance with the second digital right information and the playback management data read out by the first means.

A twelfth aspect of this invention provides a computer program comprising the steps of reading out the second digital m right information and the playback management data from the audio-information recording medium of the first aspect of this invention; and reproducing the audio objects from the audio-information recording medium and playing back the audio objects in accordance with the read-out second digital right information and the read-out playback management data.

A thirteenth aspect of this invention provides an audio-information recording medium having a data structure including first audio objects resulting from packeting a first elementary stream being compression of audio data; second audio objects resulting from packeting one of (1) linear PCM audio data being expansion of the first elementary stream and (2) a second elementary stream being compression of the linear PCM audio data; first digital right information for control of the first and second audio objects, the first digital right information being generated on the basis of second digital right information about the audio data;

and playback management data related to the first and second audio objects and generated on the basis of added data related to the audio data.

A fourteenth aspect of this invention is based on the first aspect thereof, and provides an audio-information recording medium wherein the data structure further includes one of (1) still-picture data being third elementary streams representative of one or more still pictures and (2) still-picture objects resulting from packeting the third elementary stream, the third elementary stream being contained in the added data.

A fifteenth aspect of this invention provides a recording apparatus comprising first means for packeting a first elementary stream into first audio objects, the first elementary stream being compression of audio data; second means for expanding the first elementary stream into linear PCM audio data; third means for compressing the linear PCM audio data into a second elementary stream; fourth means for packeting one of (1) the linear PCM audio data and (2) the second elementary stream into second audio objects; fifth means for generating, on the basis of first digital right information about the audio data, second digital right information related to the first and second audio objects; sixth means for generating playback management data on the basis of added data, the playback management data being related to the first and second audio objects, the added data being related to the audio data; and seventh means for recording the first and second audio objects, the second digital right information, and the playback management data on a recording medium.

A sixteenth aspect of this invention is based on the fifteenth aspect thereof, and provides a recording apparatus further comprising eighth means for extracting a third elementary stream representative of a still picture from the added data to generate still-picture data; ninth means for packeting the third elementary stream into still-picture objects; and tenth means for recording one of (1) the still-picture data and (2) the still-picture objects on the recording medium.

A seventeenth aspect of this invention is based on the sixteenth aspect thereof, and provides a recording apparatus further comprising means for receiving the first elementary stream, the first digital right information, and the added data from an electronic music distribution system.

An eighteenth aspect of this invention provides a computer program comprising the steps of packeting a first elementary stream into first audio objects, the first elementary stream being compression of audio data; expanding the first elementary stream into linear PCM audio data; compressing the linear PCM audio data into a second elementary stream; packeting one of (1) the linear PCM audio data and (2) the second elementary stream into second audio objects; generating, on the basis of first digital right information about the audio data, second digital right information related to the first and second audio objects; generating playback management data on the basis of added data, the playback management data being related to the first and second audio objects, the added data being related to the audio data; and recording the first and second audio objects, the second digital right information, and the playback management data on a recording medium.

A nineteenth aspect of this invention is based on the eighteenth aspect thereof, and provides a computer program further comprising the steps of extracting a third elementary stream representative of a still picture from the added data to generate still-picture data; packeting the third elementary stream into still-picture objects; and recording one of (1) the still-picture data and (2) the still-picture objects on the recording medium.

A twentieth aspect of this invention is based on the nineteenth aspect thereof, and provides a computer program further comprising the step of receiving the first elementary stream, the first digital right information, and the added data from an electronic music distribution system.

A twenty-first aspect of this invention provides a reproducing apparatus comprising first means for reading out the first digital right information and the playback management data from the audio-information recording medium of the thirteenth aspect of this invention; and second means for reproducing the second audio objects from the audio-information recording medium and playing back the second audio objects in accordance with the first digital right information and the playback management data read out by the first means.

A twenty-second aspect of this invention provides a computer program comprising the steps of reading out the first digital right information and the playback management data from the audio-information recording medium of the thirteenth aspect of this invention; and reproducing the second audio objects from the audio-information recording medium and playing back the second audio objects in accordance with the read-out first digital right information and the read-out playback management data.

A twenty-third aspect of this invention provides a recording and reproducing apparatus comprising the recording apparatus of the fifth aspect of this invention and the reproducing apparatus of the eleventh aspect of this invention.

A twenty-fourth aspect of this invention provides a method of transmitting or receiving a computer program comprising the steps of recording a first elementary stream, first digital right information, and added data on a recording medium, the first elementary stream resulting from encoding audio data, the first digital right information being about the audio data, the added data being related to the audio data; expanding the first elementary stream into linear PCM audio data; compressing the linear PCM audio data into a second elementary stream; packeting one of (1) the linear PCM audio data and (2) the second elementary stream into audio objects; generating second digital right information on the basis of the first digital right information, the second digital right information being related to the audio objects; generating playback management data on the basis of the added data, the playback management data being related to the audio objects; and recording the audio objects, the second digital right information, and the playback management data on the recording medium.

A twenty-fifth aspect of this invention provides a method of transmitting or receiving a computer program comprising the steps of reading out the second digital right information and the playback management data from the audio-information recording medium of the first aspect of this invention; and reproducing the audio objects from the audio-information recording medium and playing back the audio objects in accordance with the read-out second digital right information and the read-out playback management data.

A twenty-sixth aspect of this invention provides a reproducing apparatus comprising first means for reproducing information from a recording medium and second means for decoding a signal in the reproduced information which represents at least one still picture, wherein the information has been recorded on the recording medium by a method comprising the steps of recording a first elementary stream, first digital right information, and added data on a recording medium, the first elementary stream resulting from encoding audio data, the first digital right information being about the audio data, the added data being related to the audio data; expanding the first elementary stream into linear PCM audio data; compressing the linear PCM audio data into a second elementary stream; packeting one of (1) the linear PCM audio data and (2) the second elementary stream into audio objects; generating second digital right information on the basis of the first digital right information, the second digital right information being related to the audio objects; generating playback management data on the basis of the added data, the playback management data being related to the audio objects; and recording the audio objects, the second digital right information, and the playback management data on the recording medium.

A twenty-seventh aspect of this invention is based on the twenty-sixth aspect thereof, and provides a reproducing apparatus further comprising a printer interface for transmission of at least a still-picture-representing portion of the reproduced information.

A twenty-eighth aspect of this invention provides a method of transmitting or receiving data recorded according to a computer program comprising the steps of recording a first elementary stream, first digital right information, and added data on a recording medium, the first elementary stream resulting from encoding audio data, the first digital right information being about the audio data, the added data being related to the audio data; expanding the first elementary stream into linear PCM audio data; compressing the linear PCM audio data into a second elementary stream; packeting one of (1) the linear PCM audio data and (2) the second elementary stream into audio objects; generating second digital right information on the basis of the first digital right information, the second digital right information being related to the audio objects; generating playback management data on the basis of the added data, the playback management data being related to the audio objects; and recording the audio objects, the second digital right information, and the playback management data on the recording medium.

A twenty-ninth aspect of this invention provides a method of transmitting or receiving data reproduced according to a computer program comprising the steps of reading out the second digital right information and the playback management data from the audio-information recording medium of the first aspect of this invention; and reproducing the audio objects from the audio-information recording medium and playing back the audio objects in accordance with the read-out second digital right information and the read-out playback management data.

### BRIEF DESCRIPTION OF THE DRAWINGS

FIG. 1 is a diagram of the data structure of the recorded contents of a DVD-AR disc.

FIG. 2 is a diagram of the data structure of EMD contents of a type “A”.

FIG. 3 is a diagram of the data structure of EMD contents of a type “B” different from the type “A”.

FIG. 4 is a diagram of the data structure of the recorded contents of a DVD-AR disc according to a first embodiment of this invention.

FIG. 5 is a block diagram of a recording apparatus in the first embodiment of this invention.

FIG. 6 is a diagram of use of DVD-AR contents, use of EMD contents, and digital right information (usage-rule information) in the first embodiment of this invention.

FIG. 7 is a block diagram of a reproducing apparatus in the first embodiment of this invention.

FIG. 8 is a diagram of the structure of one pack.

FIG. 9 is a diagram of the data structure of the recorded contents of a DVD-AR disc according to a second embodiment of this invention.

FIG. 10 is a diagram of the data structure of the recorded contents of a DVD-AR disc according to a third embodiment of this invention.

FIG. 11 is a diagram of use of DVD-AR contents, use of EMD contents, and digital right information (usage-rule information) in the third embodiment of this invention.

FIG. 12 is a diagram of the data structure of the recorded contents of a DVD-AR disc according to a fourth embodiment of this invention.

FIG. 13 is a block diagram of a reproducing and transmitting apparatus in the fourth embodiment of this invention.

FIG. 14 is a block diagram of a recording and reproducing apparatus in a fifth embodiment of this invention.

FIG. 15 is a flowchart of a recording-related segment of a control program for a computer in FIG. 14.

FIG. 16 is a flowchart of a reproduction-related segment of the control program for the computer in FIG. 14.

FIG. 17 is a block diagram of an apparatus in a sixth embodiment of this invention.

FIG. 18 is a flowchart of a transmission-related segment of a control program for a computer in FIG. 17.

FIG. 19 is a flowchart of a reception-related segment of the control program for the computer in FIG. 17.

### DETAILED DESCRIPTION OF THE INVENTION

### First Embodiment

The DVD-VR standards are unsuited for the recording of only audio data on a disc. According to the DVD-VR standards, it is mandatory that each VOB contains a video stream. Thus, it is difficult to record only audio data on a disc. Here, a DVD-RW disc or a DVD-RAM disc designed for mainly storing audio contents is referred to as a DVD audio recording disc (a DVD-AR disc). The DVD-AR disc is similar to the DVD-VR disc as indicated hereafter.

The DVD-AR disc is a modification of a DVD-VR disc. Preferably, the DVD-AR disc is basically compatible with a DVD-VR disc.

The DVD-AR disc is designed as follows. Audio data are recorded on a DVD-AR disc as audio objects (AOBs) corresponding to VOBs in a DVD-VR disc. The DVD-AR disc is also loaded with original management data and user defined management data. The original management data represent an original PGC (program chain) used for sequentially reproducing AOBs from the disc in an order equal to that of the recording of the AOBs on the disc. The user defined management data represent a user defined PGC or PGCs. Each user defined PGC relates to ones among the AOBs and portions of the AOBs which are selected by a user. The user defined PGC is used for sequentially reproducing the selected AOBs and the selected portions of the AOBs in an order desired by the user. On each disc, there is only one original PGC and one or more user defined PGCs.

FIG. 1 shows the data structure of the recorded contents 10 of a DVD-AR disc. The DVD-AR contents 10 include DVD-AR audio objects (AOBs) 13, copy control information (CCI) 12a, and playback management data 11. The AOBs 13 are real audio data. The copy control information 12a relates to the AOBs 13. The playback management data 11 include original management data and user defined management data. The playback management data 11 are also referred to as the navigation information 11. The copy control information 12a is also referred to as the usage-rule information 12a. The AOBs 13 and the copy control information 12a are protected by a copyright protection scheme such as CPRM (content protection for recordable media).

According to CPRM, the AOBs 13 are encrypted, and copying the AOBs 13 are controlled among three levels, that is, “copy free”, “copy permitted only for a first generation”, and “copy prohibited”.

Some digital recording mediums such as CDs or DVD-Audios store linear PCM audio data. It is possible that linear PCM audio data are reproduced from such a digital recording medium, and are then copied onto a DVD-AR disc. The reproduced linear PCM audio data may be compressed by a lossless encoding procedure or a lossy encoding procedure before being copied onto the DVD-AR disc. During the copying of the audio data from the digital recording medium onto the DVD-AR disc, a signal representative of “copy prohibited” is written in copy control information to prevent the production of a second-generation copy.

An electronic music distribution (EMD) system sends compressed audio data to users in a manner such that the copyright on the contents of the audio data can be protected. The EMD system uses an audio-data compressively-encoding procedure to generate compressed audio data. The audio-data compressively-encoding procedure used by the EMD system is selected from MP3 (MPEG Audio Layer 3), AAC (MPEG Audio AAC), ATRAC3 (Adaptive Transform Acoustic Coding 3), WMA (Windows Media Audio), TwinVQ (Transform-Domain Weighted Interleave Vector Quantization), and others. The EMD system uses a copyright protection scheme which is selected from EMMS, DRM, Liquid Audio, WMT, and others.

In general, the EMD system conforms to the copyright protection standards proposed by SDMI (Secure Digital Music Initiative). According to the SDMI standards, copying and moving the contents of audio data are controlled on the basis of digital right information representing usage rules and appended to the contents. In an example of the contents-copying/moving control, for each set of the contents, up to three first-generation copies thereof are permitted. This action is referred to as checkout. The number of copies permitted decreases as the number of copies which have been made increases. When a copy or copies are returned to a copy source, the number of copies permitted is increased back to the previous number. The return of a copy or copies to a copy source is referred to as check-in. The copy control via checkout and checkin causes at most three copies to be present. The parent side (the hotel side) with respect to checkout and check-in is referred to as an LCM (license compliant module), and the child side (the customer side) with respect thereto is referred to as PM (portable media) or a portable device.

As understood from the above description, the usage-rule information (the digital right information) includes information about checkout and check-in. The usage-rule information may include not only information about checkout and check-in but also various types of control information. A first example of the control information is designed to limit a term for which the playback of the related contents is permitted, and to inhibit the playback after the expiry of the term. A second example of the control information is designed to limit the number of times the related contents are played back, and to inhibit the playback after the limited number of times has been reached.

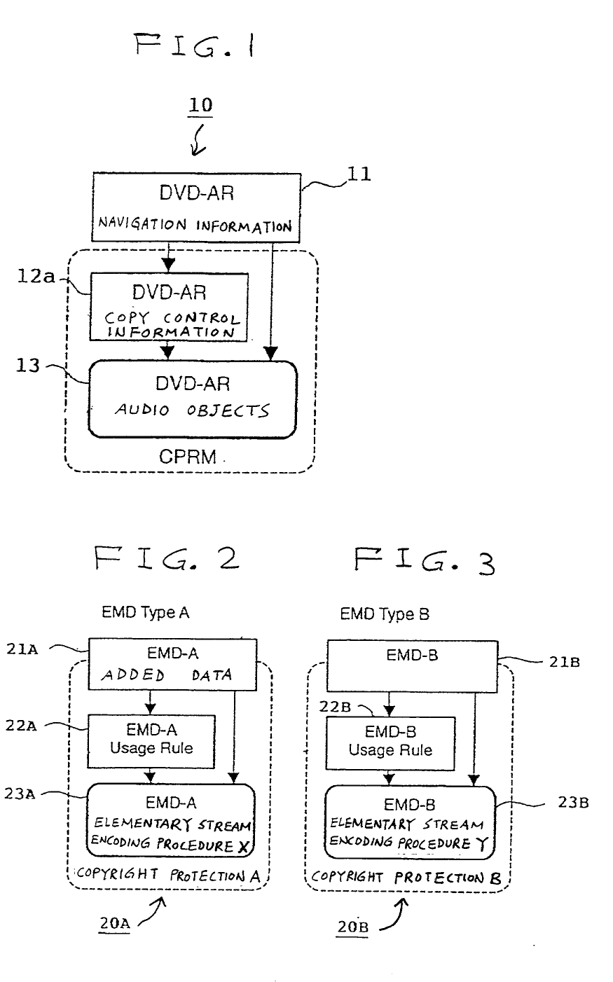

FIG. 2 shows the data structure of the EMD contents 20A of a type “A”. The EMD contents 20A include EMD added data 21A, EMD usage-rule information 22A, and an EMD elementary stream 23A of compressed audio data. The compressed audio data are generated by an encoding procedure “X”. The EMD added data 21A include, for example, added contents representative of a still picture, text information representative of tune names, and an ISRC code signal identifying the related contents. At least portions of the EMD added data 21A, the EMD usage-rule information 22A, and the EMD elementary stream 23A are encrypted according to a first copyright protection scheme.

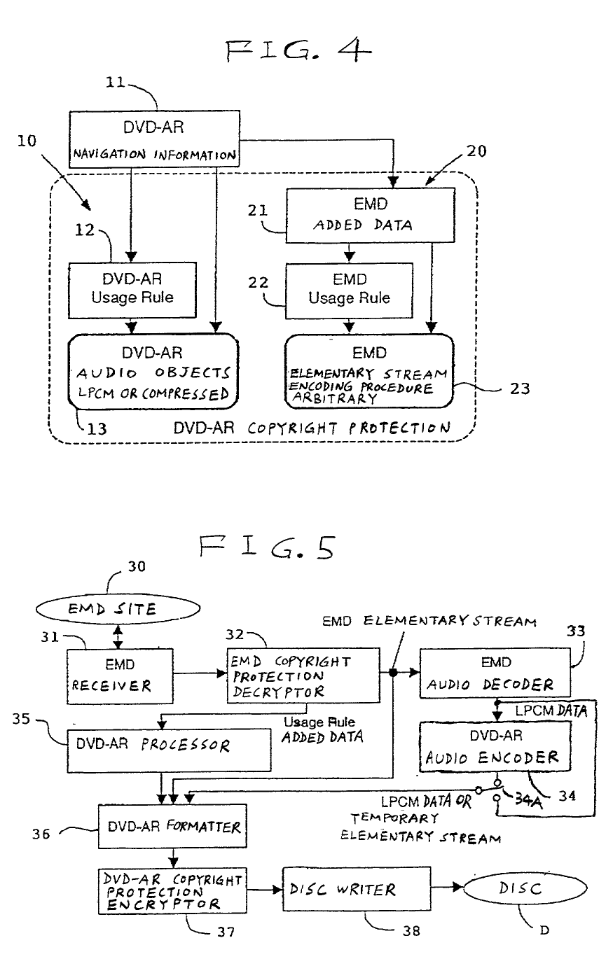

FIG. 3 shows the data structure of the EMD contents 20B of a type “B” different from the type “A”. The EMD contents 20B include EMD added data 21B, EMD usage-rule information 22B, and an EMD elementary stream 23B of compressed audio data. The compressed audio data are generated by an encoding procedure “Y” different from the encoding procedure “X”. Basically, the EMD added data 21B are different from the EMD added data 21A. The EMD added data 21B include, for example, added contents representative of a still picture, text information representative of tune names, and an ISRC code signal identifying the related contents. At least portions of the EMD added data 21B, the EMD usage-rule information 22B, and the EMD elementary stream 23B are encrypted according to a second copyright protection scheme different from the first copyright protection scheme.

With reference to FIG. 4, EMD contents 20 are transmitted from an EMD system (not shown). The EMD contents 20 include EMD added data 21, EMD usage-rule information 22, and an EMD elementary stream 23 of compressed audio data. The EMD added data 21, the EMD usage-rule information 22, and the EMD elementary stream 23 are recorded on a DVD-AR disc together with DVD-AR contents 10. Specifically, the EMD elementary stream 23 is recorded on the DVD-AR disc in two ways. The EMD elementary stream 23 is recorded as it is. Also, the EMD elementary stream 23 is recorded as DVD-AR audio objects. Thus, the EMD elementary stream is recorded dually or doubly. The DVD-AR contents 10 include DVD-AR navigation information 11, DVD-AR usage-rule information 12, and DVD-AR audio objects (AOBs) 13. The DVD-AR audio objects 13 are formed by the EMD elementary stream 23. The DVD-AR navigation information 11 refers to the EMD contents 20. Accordingly, the DVD-AR navigation information 11 defines the relation between the DVD-AR contents 10 and the EMD contents 20 or the relation between the DVD-AR audio objects 13 and the EMD elementary stream 23. In FIG. 4, a copyright protection scheme for the EMD contents 20 is changed to that for the DVD-AR contents 10. Access to the DVD-AR usage-rule information 12, the DVD-AR audio objects 13, and the EMD added data 21 can be controlled in response to the DVD-AR navigation information 11.

FIG. 5 shows an apparatus for recording the DVD-AR contents 10 and the EMD contents 20 on a DVD-.AR disc “D” according to a first embodiment of this invention. The recording apparatus of FIG. 5 includes an EMD receiver 31 which can be connected with an EMD system site 30 via a communication network such as the Internet. The EMD receiver 31 receives the EMD contents 20 from the EMD system site 30. The EMD receiver 31 feeds the received EMD contents 20 to an EMD decryptor 32. The EMD decryptor 32 decrypts the EMD contents 20 into non-encrypted EMD contents according to a decrypting procedure determined by the copyright protection scheme for the EMD contents 20. The EMD decryptor 32 demultiplexes or separates the non-encrypted EMD contents into the EMD added data 21, the EMD usage-rule information 22, and the EMD elementary stream 23. The EMD decryptor 32 feeds the EMD elementary stream 23 to an EMD audio decoder 33 and a DVD-AR formatter 36. The EMD decryptor 32 feeds the EMD added data 21 and the EMD usage-rule information 22 to a DVD-AR processor 35.

The EMD audio decoder 33 expansively decodes the EMD elementary stream 23 into linear PCM audio data (LPCM audio data). The EMD audio decoder 33 feeds the LPCM audio data to a DVD-AR audio encoder 34 and a switch 34A. According to a given compressively encoding procedure of a lossless type or a lossy type, the DVD-AR audio encoder 34 compressively encodes the LPCM audio data into a temporary elementary stream of compressed audio data of a prescribed form other than the LPCM form. The DVD-AR audio encoder 34 feeds the temporary elementary stream to the switch 34A. The switch 34A selects either the LPCM audio data or the temporary elementary stream, and passes the selected one to the DVD-AR formatter 36. The switch 34A may be controlled by a suitable device.

The DVD-AR processor 35 generates the DVD-AR navigation information 11 in response to the EMD added data 21. The DVD-AR processor 35 converts the EMD usage-rule information 22 into the DVD-AR usage-rule information 12. The DVD-AR processor 35 outputs the DVD-AR navigation information 11, the DVD-AR usage-rule information 12, the EMD added data 21, and the EMD usage-rule information 22 to the DVD-AR formatter 36. The DVD-AR processor 35 may control the switch 34A. For example, the DV-DAR processor 35 includes a CPU or a DSP programmed to execute the above-indicated steps of operation.

The DVD-AR formatter 36 multiplexes or combines the EMD added data 21, the EMD usage-rule information 22, and the EMD elementary stream 23 into an EMD-contents signal of a prescribed DVD-AR format. The DVD-AR formatter 36 packets the LPCM audio data outputted from the EMD audio decoder 33 or the temporary elementary stream outputted from the DVD-AR audio encoder 34.

In other words, the DVD-AR formatter 36 converts the LPCM audio data or the temporary elementary stream into a string of packets which is referred to as a packet signal. Specifically, the DVD-AR formatter 36 converts the LPCM audio data or the temporary elementary stream into DVD-AR audio objects (AOBs) 13 composing the packet signal. The DVD-AR formatter 36 multiplexes or combines the DVD-AR navigation information 11, the DVD-AR rule-usage information 12, and the DVD-AR audio objects 13 into a DVD-AR-contents signal of the prescribed DVD-AR format. The DVD-AR formatter 36 outputs a sequence of the EMD-contents signal and the DVD-AR-contents signal to a DVD-AR encryptor 37.

The DVD-AR encryptor 37 encrypts at least a portion of the sequence of the EMD-contents signal and the DVD-AR-contents signal into an encryption-resultant signal according to an encrypting procedure determined by the copyright protection scheme for the DVD-AR contents 10. The DVD-AR encryptor 37 outputs the encryption-resultant signal to a disc writer (a disc drive) 38. The disc writer 38 records the encryption-resultant signal on the DVD-2 AR disc “D”.

The DVD-AR audio objects (AOBs) in the DVD-AR contents 10 originate from the EMD elementary stream 23. The recording of the DVD-AR contents 10 on the DVD-AR disc “D” is intended for DVD-AR-compatible playback of the EMD contents 20. Therefore, it is unnecessary for the DVD-AR contents 10 to take SDMI checkout and check-in control. On the other hand, the EMD contents 20 hold the EMD usage-rule information 22 via which SDMI checkout and check-in control can be implemented.

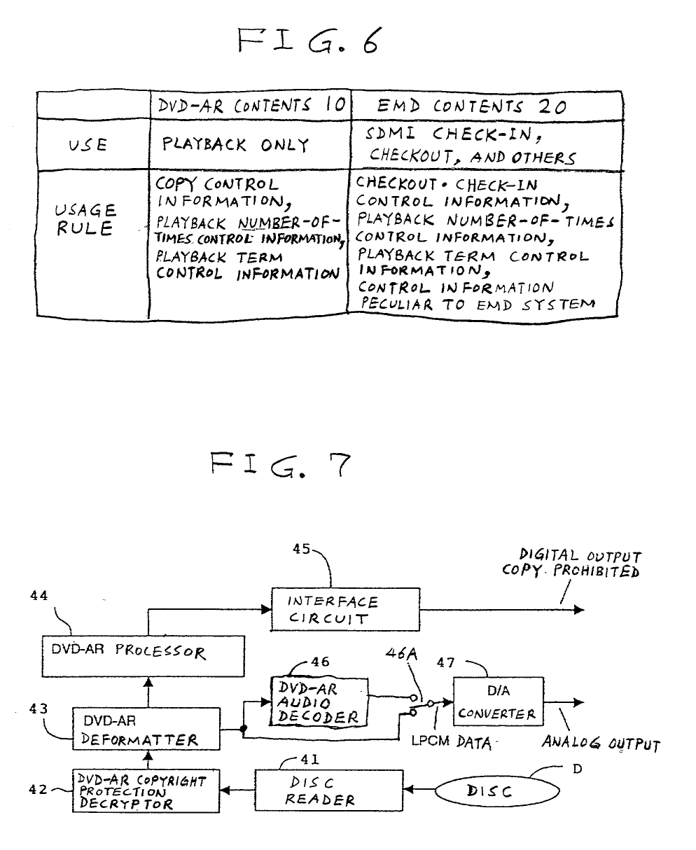

With reference to FIG. 6, the EMD contents 20 are used for checkout and check-in in conformity with the SDMI standards. The EMD usage-rule information 22 may include checkout and check-in control information, information of controlling the number of times the EMD contents 20 are played back (playback number-of-times control information), information of controlling a term for which the playback of the EMD contents 20 is permitted (playback term control information), and other control information peculiar to the EMD system. The playback number-of-times control information and the playback term control information if any are written in the DVD-AR usage-rule information 12. The DVD-AR contents 10 are used only for playback. The DVD-AR usage-rule information 12 includes copy control information, playback number-of-times control information identical to that in the EMD contents 20, and playback term control information identical to that in the EMD contents 20. Basically, the copy control information in the DVD-AR usage-rule information 12 is set to a state of “copy prohibited”. Preferably, the DVD-AR usage-rule information 12 is exclusive of the control information peculiar to the EMD system.

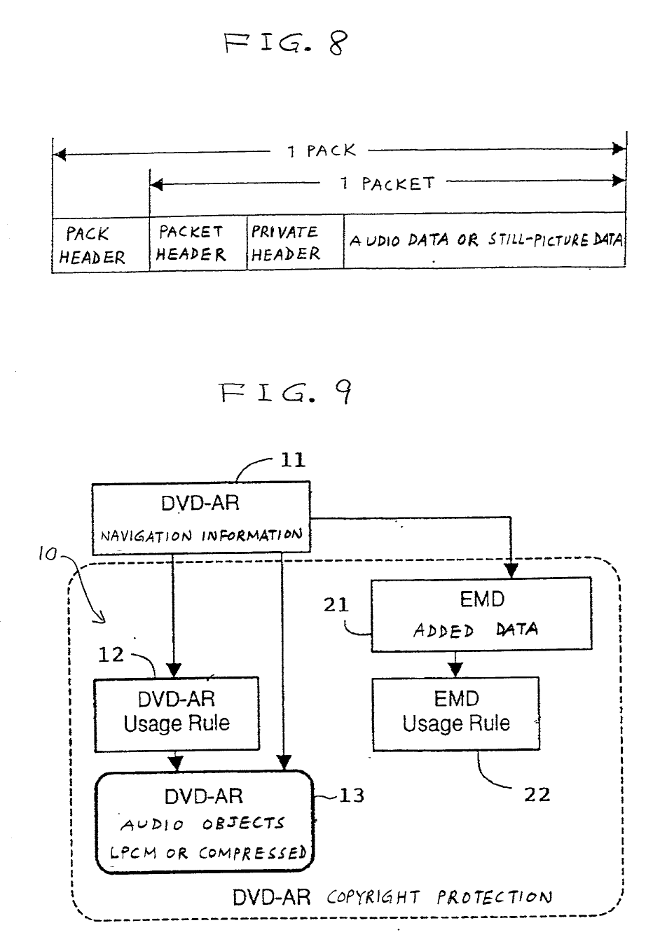

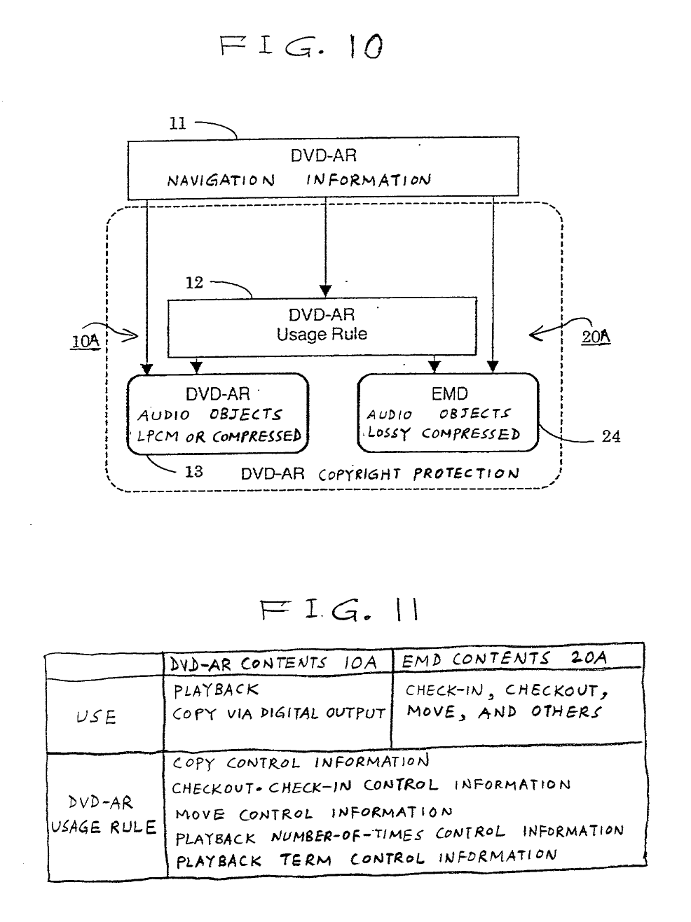

FIG. 7 shows an apparatus for reproducing the DVD-AR contents 10 from the DVD-AR disc “D” according to the first embodiment of this invention. The DVD-AR disc “D” stores the encryption-resultant signal representing the DVD-AR contents 10.

The reproducing apparatus of FIG. 7 includes a disc reader 41. The disc reader 41 accesses the DVD-AR disc “D”, and reads out the encryption-resultant signal therefrom. The disc reader 41 outputs the read-out encryption-resultant signal to a DVD-AR decryptor 42.

The DVD-AR decryptor 42 decrypts the read-out encryption-resultant signal into the DVD-AR-contents signal according to a decrypting procedure determined by the copyright protection scheme for the DVD-AR contents 10. The DVD-AR decryptor 42 outputs the DVD-AR-contents signal to a DVD-AR deformatter 43. The DVD-AR deformatter 43 demultiplexes or separates the DVD-AR-contents signal into the DVD-AR navigation information 11, the DVD-AR rule-usage information 12, and the DVD-AR audio objects 13. The DVD-AR deformatter 43 de-packets the DVD-AR audio objects 13 into the LPCM audio data or the temporary elementary stream. The DVD-AR deformatter 43 outputs the DVD-AR navigation information 11, the DVD-AR rule-usage information 12, and the LPCM audio data or the temporary elementary stream to a DVD-AR processor 44. In addition, the DVD-AR deformatter 43 can output the LPCM audio data or the temporary elementary stream to a DVD-AR audio decoder 46 and a switch 46A.

A preferable data reproduction order is as follows. First, the DVD-AR navigation information 11 is reproduced from the DVD-AR disc “D”. Second, the DVD-AR audio objects 13 are reproduced from the DVD-AR disc “D” and are played back in accordance with the DVD-AR navigation information 11.

The DVD-AR processor 44 decides whether the playback of the DVD-AR contents 10 is permitted or prohibited on the basis of the DVD-AR usage-rule information 12. For example, when it is found from the playback term control information in the DVD-AR usage-rule information 12 that the term for which the playback of the DVD-AR contents 10 is permitted has already expired, the DVD-AR processor 44 decides that the playback of the DVD-AR contents is prohibited. When it is decided that the playback of the DVD-AR contents 10 is permitted, the DVD-AR processor 44 enables the DVD-AR deformatter 43 to output the LPCM audio data or the temporary elementary stream to the DVD-AR audio decoder 46 and the switch 46A. When it is decided that the playback of the DVD-AR contents 10 is prohibited, the DVD-AR processor 44 prevents the DVD-AR deformatter 43 from outputting the LPCM audio data or the temporary elementary stream to the DVD-AR audio decoder 46 and the switch 46A.

According to a given expansively decoding procedure of a lossless type or a lossy type, the DVD-AR audio decoder 46 expansively decodes the temporary elementary stream into the LPCM audio data. The DVD-AR audio decoder 46 outputs the LPCM audio data to the switch 46A. When the DVD-AR deformatter 43 outputs the LPCM audio data, the outputted LPCM audio data are selected by the switch 46A and are passed to a digital-to-analog (D/A) converter 47. When the DVD-AR deformatter 43 outputs the temporary elementary stream, the LPCM audio data outputted from the DVD-AR audio decoder 46 are selected by the switch 46A and are passed to the D/A converter 47. The switch 46A may be controlled by the DVD-AR processor 44 or another device (not shown). The D/A converter 47 changes the LPCM audio data outputted from the DVD-AR deformatter 43 or the DVD-AR audio decoder 46 into a corresponding analog audio signal. The D/A converter 47 outputs the analog audio signal.

When it is decided that the playback of the DVD-AR contents is permitted, the DVD-AR processor 44 generates copy control information (copy management information) in response to the DVD-AR rule-usage information 12. Basically, the generated copy control information is in a state of “copy prohibited”. The DVD-AR processor 44 adds the copy control information to the LPCM audio data or the temporary elementary stream to generate addition-resultant audio data. The DVD-AR processor 44 outputs the addition-resultant audio data to an interface circuit 45. When it is decided that the playback of the DVD-AR contents 10 is prohibited, the DVD-AR processor 44 fails to transmit the LPCM audio data or the temporary elementary stream to the interface circuit 45. For example, the DVD-AR processor 44 includes a CPU or a DSP programmed to execute the above-indicated steps of operation. The interface circuit 45 converts the addition-resultant audio data into a digital audio signal of a prescribed format suited for transmission. The interface circuit 45 outputs the digital audio signal to, for example, a home server.

The read-out encryption-resultant signal outputted from the disc reader 41 to the DVD-AR decryptor 42 may include the EMD-contents signal. In this case, the DVD-AR decryptor 42 decrypts the read-out encryption-resultant signal into the EMD-contents signal according to the decrypting procedure determined by the copyright protection scheme for the DVD-AR contents 10. The DVD-AR decryptor 42 outputs the EMD-contents signal to the DVD-AR deformatter 43. The DVD-AR deformatter 43 demultiplexes or separates the EMD-contents signal into the EMD added data 21, the EMD usage-rule information 22, and the EMD elementary stream 23. The DVD-AR deformatter 43 feeds the EMD added data 21, the EMD usage-rule information 22, and the EMD elementary stream 23 to the DVD-AR processor 44. The DVD-AR processor 44 is programmed to implement SDMI checkout and check-in control of the EMD elementary stream 23 in response to the EMD usage-rule information 22.

Preferably, the DVD-AR contents 10 and the EMD contents 20 are encrypted by the DVD-AR encryptor 37 in the same encrypting procedure determined by the DVD-AR copyright protection scheme. Preferably, the encryption-resultant DVD-AR contents and the encryption-resultant EMD contents are recorded in a same file on the DVD-AR disc “D”. In this case, the audio information common to the DVD-AR contents 10 and the EMD contents 20 can easily be managed as a single file.

According to another example of encryption, the DVD-AR contents 10 are encrypted in the encrypting procedure determined by the DVD-AR copyright protection scheme while the EMD contents 20 are encrypted in an encrypting procedure given by the EMD copyright protection scheme. In this case, it is preferable to record the encryption-resultant DVD-AR contents and the encryption-resultant EMD contents in separate files on the DVD-AR disc “D” respectively. The relation between the DVD-AR contents and the EMD contents 20 is managed by use of the DVD-AR navigation information 11.

According to still another example of encryption, the DVD-AR contents 10 are encrypted in the encrypting procedure determined by the DVD-AR copyright protection scheme while the EMD contents 20 are encrypted in an encrypting procedure given by the EMD copyright protection scheme. The encryption-resultant EMD contents are further encrypted in the encrypting procedure determined by the DVD-AR copyright protection scheme. In this case, it is preferable to record the encryption-resultant DVD-AR contents and the further-encryption-resultant EMD contents in a same file on the DVD-AR disc “D”.

It should be noted that the recording apparatus of FIG. 5 and the reproducing apparatus of FIG. 7 may be combined into a recording and reproducing apparatus.

As previously mentioned, the DVD-AR formatter 36 implements the packeting of the LPCM audio data or the temporary elementary stream. Here, “packeting” means (1) dividing, for example, the temporary elementary stream into units, and (2) adding a header to each of the units. Each header-added unit is referred to as a packet. The packeting generates a packeted elementary stream referred to as a packet signal. A pack header may be added to each packet to form a pack. FIG. 8 shows an example of the structure of one pack. In FIG. 8, one pack is composed of a pack header and a packet. The packet has a packet header, a private header, and audio data. The packet header includes, for example, synchronizing information and time-related information (time-stamp information). The private header is loaded with private information. The private header may be omitted from the packet. The audio data may be replaced by still-picture data. A sequence of packs forms, for example, an MPEG program stream or an MPEG transport stream.

### Second Embodiment

A second embodiment of this invention is similar to the first embodiment thereof except for design changes mentioned hereafter. The second embodiment of this invention does not implement the directly recording of the EMD elementary stream 23 on the DVD-AR disc “D”. In the second embodiment of this invention, the EMD decryptor 32 does not feed the EMD elementary stream 23 to the DVD-AR formatter 36 (see FIG. 5).

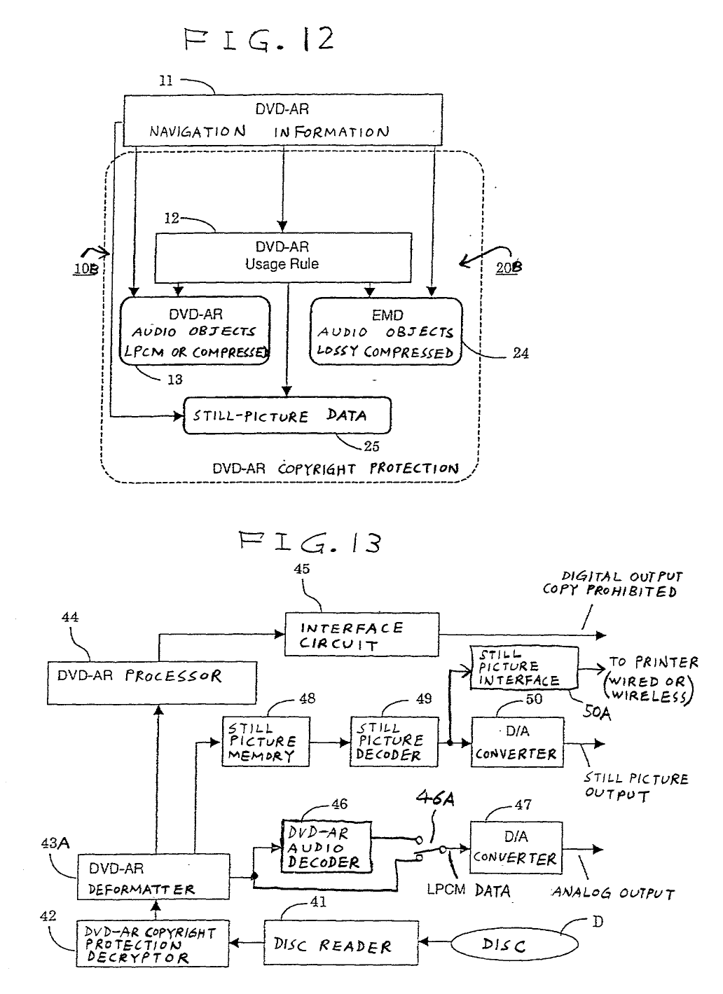

With reference to FIG. 9, the EMD added data 21 and the EMD usage-rule information 22 are recorded on the DVD-AR disc together with the DVD-AR contents 10. The EMD elementary stream 23 in the EMD contents 20 is recorded on the DVD-AR disc as DVD-AR audio objects (AOBs) 13. The EMD elementary stream is not directly recorded thereon. The DVD-AR contents 10 include the DVD-AR navigation information 11, the DVD-AR usage-rule information 12, and the DVD-AR audio objects 13. The DVD-AR audio objects 13 are formed by the EMD elementary stream 23.

Access to the DVD-AR usage-rule information 12, the DVD-AR audio objects 13, and the EMD added data 21 can be controlled in response to the DVD-AR navigation information 11.

The second embodiment of this invention is applied to a first case or a second case. The first case is that the DVD-AR disc “D” is used as portable media (PM). In the first case, since the DVD-AR disc “D” is not used as an LCM (license compliant module), it is unnecessary to handle checkout from the DVD-AR disc “D” to an external device. Thus, it is unnecessary to directly record the EMD elementary stream 23 on the DVD-AR disc “D” which is required for checkout. On the other hand, the DVD-AR disc “D” stores the EMD usage-rule information 22 required for control of check-in from the DVD-AR disc “D” to the parent LCM. The portable media are used for playback. The second case is that the DVD-AR audio-data encoding procedure to generate DVD-AR compressed audio data and the EMD audio-data encoding procedure to generate EMD compressed audio data are the same. In the second case, it is unnecessary to directly record the EMD elementary stream 23 on the DVD-AR disc “D” even when the DVD-AR disc “D” is used as an LCM. During checkout, the EMD elementary stream 23 is recovered from the DVD-AR audio objects 13.

### Third Embodiment

A third embodiment of this invention is similar to the first embodiment thereof except for design changes mentioned hereafter.

With reference to FIG. 10, EMD contents 20A are transmitted from an EMD system (not shown). The EMD contents 20A include EMD added data 21, EMD usage-rule information 22, and an EMD elementary stream 23 of compressed audio data. The EMD added data 21 and the EMD usage-rule information 22 are not directly recorded on the DVD-AR disc “D”. The EMD elementary stream 23 is packeted by the DVD-AR formatter 36 (see FIG. 5) into EMD audio objects (AOBs) 24 composing a packet signal. The EMD audio objects 24 are recorded on the DVD-AR disc “D”. The EMD audio objects 24 are formed by EMD audio information compressed by a lossy compressively-encoding procedure. At least a portion of the EMD added data 21 including the text information is converted into the DVD-AR navigation information 11. The EMD usage-rule information 22 is converted into the DVD-AR usage-rule information 12.

As shown in FIG. 10, the DVD-AR contents 10A include the DVD-AR audio objects (AOBs) 13, the DVD-AR usage-rule information 12, and the DVD-AR navigation information 11. The EMD contents 20A include the EMD audio objects (AOBs) 24, the DVD-AR usage-rule information 12, and the DVD-AR navigation information 11. Access to the DVD-AR usage-rule information 12, the DVD-AR audio objects 13, and the EMD audio objects 24 can be controlled in response to the DVD-AR navigation information 11.

As previously mentioned, the EMD added data 21 and the EMD usage-rule information 22 are not directly recorded on the DVD-AR disc “D”. The EMD added data 21 and the EMD usage-rule information 22 are converted by the DVD-AR processor 35 (see FIG. 5) into the DVD-AR navigation information 11 and the DVD-AR usage-rule information 12, respectively. The DVD-AR navigation information 11 and the DVD-AR usage-rule information 12 are recorded on the DVD-AR disc “D”. As previously mentioned, the EMD elementary stream 23 is converted by the DVD-AR formatter (see FIG. 5) into the EMD audio objects 24.

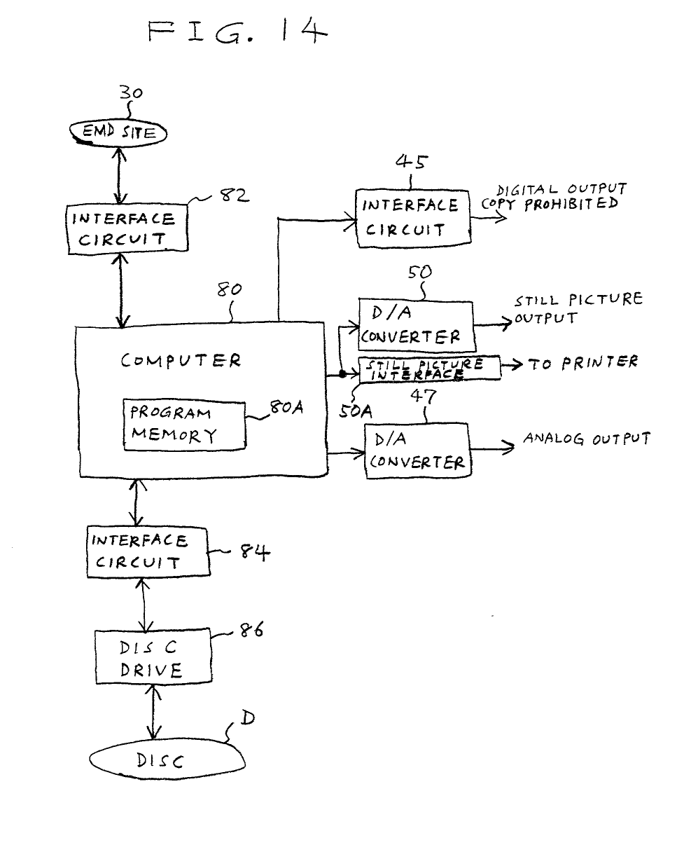

With reference to FIG. 11, the recording of the DVD-AR contents 10A on the DVD-AR disc “D” is intended for DVD-AR-compatible playback of the EMD contents 20A. Therefore, the DVD-AR contents 10A are used for a playback purpose and a copying procedure including a step of outputting a digital audio signal. The number of times the DVD-AR contents 10A are played back, and also the term for which the playback of the DVD-AR contents 10A is permitted may be limited. The EMD contents 20A are used for checkout, check-in, and move in which the lossy compressed audio information is transmitted and received as it is. The DVD-AR contents 10A may be moved. Usage rules for handling the DVD-AR contents 10A and the EMD contents 20A employ those represented by the DVD-AR usage-rule information 12.

### Fourth Embodiment

A fourth embodiment of this invention is similar to one of the first, second, and third embodiments thereof except for design changes mentioned hereafter. In the fourth embodiment of this invention, data representative of a still picture are extracted from the EMD added data 21, and the still-picture data are recorded on the DVD-AR disc “D”. The still-picture data result from a JPEG-based compressively-encoding procedure. The still-picture data may use MPEG data representative of an intra-encoded frame.

With reference to FIG. 12, EMD contents 20B are transmitted from an EMD system (not shown). The EMD contents 20B include EMD added data 21, EMD usage-rule information 22, and an EMD elementary stream 23 of compressed audio data. The EMD added data 21 and the EMD usage-rule information 22 are not directly recorded on the DVD-AR disc “D”. The EMD elementary stream 23 is packeted by the DVD-AR formatter 36 (see FIG. 5) into EMD audio objects (AOBs) 24 composing a packet signal. The EMD audio objects 24 are recorded on the DVD-AR disc “D”. The EMD audio objects 24 are formed by EMD audio information compressed by a lossy compressively-encoding procedure. At least a portion of the EMD added data 21 including the text information is converted into the DVD-AR navigation information 11. The EMD usage-rule information 22 is converted into the DVD-AR usage-rule information 12.

The DVD-AR processor 35 (see FIG. 5) extracts data 25 representative of a still picture from the EMD added data 21. The still-picture data 25 are transmitted from the DVD-AR processor 35 to the disc writer 38 via the DVD-AR formatter 36 and the DVD-AR encryptor 37 before being recorded on the DVD-AR disc “D” by the disc writer 38 (see FIG. 5). Preferably, the still-picture data 25 are encrypted by the DVD-AR encryptor 37. In general, the still-picture data (the encryption-resultant still-picture data) 25 are recorded as a JPEG elementary stream. The recorded still-picture 25 may be of a format based on the JPEG elementary stream. A JPEG elementary stream loaded with the still-picture data 25 may be packeted into still-picture objects before being recorded on the DVD-AR disc “D”. Copying or moving the still-picture data 25 from the DVD-AR disc “D” is controlled in response to the DVD-AR usage-rule information 12. Generally, the audio information and the still-picture data 25 in the EMD contents 20B are simultaneously subjected to check-in, checkout, or move. Alternatively, the audio information and the still-picture data 25 in the EMD contents 20B may be subjected to check-in, checkout, or move separately from each other.

As shown in FIG. 12, the DVD-AR contents 10B include the DVD-AR audio objects (AOBs) 13, the DVD-AR usage-rule information 12, the DVD-AR navigation information 11, and the still-picture data 25. The EMD contents 20B include the EMD audio objects (AOBs) 24, the DVD-AR usage-rule information 12, the DVD-AR navigation information 11, and the still-picture data 25. Access to the DVD-AR usage-rule information 12, the DVD-AR audio objects 13, the EMD audio objects 24, and the still-picture data 25 can be controlled in response to the DVD-AR navigation information 11.

As previously mentioned, the EMD added data 21 and the EMD usage-rule information 22 are not directly recorded on the DVD-AR disc “D”. The EMD added data 21 are converted by the DVD-AR processor 35 (see FIG. 5) into the DVD-AR navigation information 11 and the still-picture data 25. The EMD usage-rule information 22 is converted by the DVD-AR processor 35 into the DVD-AR usage-rule information 12. The DVD-AR navigation information 11, the still-picture data 25, and the DVD-AR usage-rule information 12 are recorded on the DVD-AR disc “D”. Specifically, the DVD-AR processor 35 outputs an EMD elementary stream, for example, a JPEG elementary stream, representative of a still picture to the DVD-AR formatter 36 (see FIG. 5). The DVD-AR formatter 36 converts the EMD elementary stream into sill-picture data 25 of a prescribed format suited for recording on the DVD-AR disc “D”. The still-picture data 25 are transmitted from the DVD-AR formatter 36 to the disc writer 38 via the DVD-AR encryptor 37 (see FIG. 5). Preferably, the still-picture data 25 are encrypted by the DVD-AR encryptor 37. The disc writer 38 records the still-picture data (the encryption-resultant still-picture data) 25 on the DVD-AR disc “D”. As previously mentioned, the EMD elementary stream 23 is converted by the DVD-AR formatter 36 into the EMD audio objects 24.

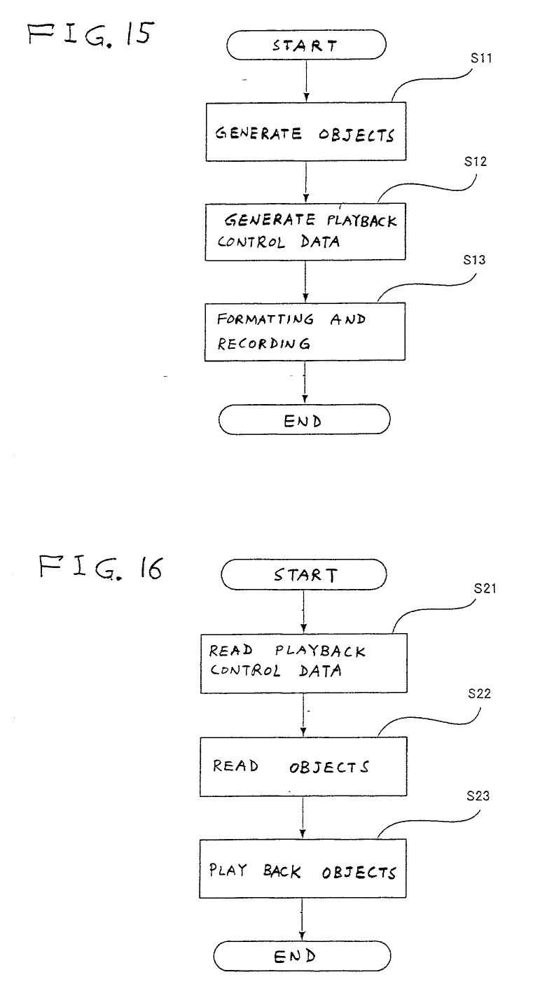

FIG. 13 shows an apparatus for reproducing and transmitting the DVD-AR contents 10B from the DVD-AR disc “D” according to the fourth embodiment of this invention. The reproducing and transmitting apparatus of FIG. 13 is similar to that of FIG. 7 except for additional arrangements mentioned hereafter. The reproducing and transmitting apparatus of FIG. 13 includes a DVD-AR deformatter 43A instead of the DVD-AR deformatter 43 (see FIG. 7).

The reproducing and transmitting apparatus of FIG. 13 further includes a memory 48, a still-picture decoder 49, and a D/A converter 50 successively following the DVD-AR deformatter 43A.

During the reproduction of the DVD-AR contents 10B from the DVD-AR disc “D”, the disc reader 41 reads out the encryption-resultant signal therefrom. The disc reader 41 outputs the read-out encryption-resultant signal to the DVD-AR decryptor 42. The DVD-AR decryptor 42 decrypts the read-out encryption-resultant signal to get a decryption-resultant signal. The DVD-AR decryptor 42 outputs the decryption-resultant signal to the DVD-AR deformatter 43A. The DVD-AR deformatter 43A demultiplexes or separates the decryption-resultant signal into the DVD-AR navigation information 11, the DVD-AR rule-usage information 12, the LPCM audio data or the temporary elementary stream, and the still-picture data 25. The DVD-AR deformatter 43A outputs the DVD-AR navigation information 11, the DVD-AR rule-usage information 12, and the LPCM audio data or the temporary elementary stream to the DVD-AR processor 44. In addition, the DVD-AR deformatter 43A can output the LPCM audio data or the temporary elementary stream to the DVD-AR audio decoder 46 and the switch 46A. The DVD-AR deformatter 43A stores the still-picture data 25 into the memory 48. The still-picture data 25 in the memory 48 indicate all of still pictures to be played back together with the audio information represented by the LPCM audio data or the temporary elementary stream.

During the playback of the audio information represented by the LPCM audio data or the temporary elementary stream, every 1-frame-corresponding portion of the still-picture data 25 is transferred from the memory 48 to the still-picture decoder 49 at a prescribed time point under the control by, for example, the DVD-AR processor 44. The still-picture decoder 49 decodes the 1-frame-corresponding portion of the still-picture data 25 into a 1-frame-corresponding digital still-picture signal. The still-picture decoder 49 outputs the 1-frame-corresponding digital still-picture signal to the D/A converter 50. The D/A converter 50 changes the 1-frame-corresponding digital still-picture signal into a corresponding analog signal of an NTSC or PAL television format which indicates a 1-frame still picture. The D/A converter 50 outputs the analog still-picture signal.

The still-picture decoder 49 outputs the digital still-picture signal to a still-picture interface circuit 50A. The still-picture interface circuit 50A converts the format of the output signal of the still-picture decoder 49 into a format suited for transmission to a printer (not shown), for example, a format conforming to the USB standards. The still-picture interface circuit 50A is connected with the printer on a wireless or wired basis. A signal representative of “copy prohibited” may be contained in a still-picture signal directed to the printer. The still-picture interface circuit 50A may execute the addition of a “copy prohibited” signal into a still-picture signal directed to the printer. The still-picture interface 50A may respond to the “copy prohibited” signal as follows. In the presence of a “copy prohibited” signal in a still-picture signal directed to the printer, the still-picture interface circuit 50A prohibits the transmission of the still-picture signal to the printer. In the absence of a “copy prohibited” signal from a still-picture signal directed to the printer, the still-picture interface circuit 50A permits and executes the transmission of the still-picture signal to the printer.

The reproduction of the audio data and the still-picture data from the DVD-AR disc “D” may be based on a prior-art method such as one disclosed in European patent application EP 0962931 Al, the disclosure of which is hereby incorporated by reference.

### Fifth Embodiment

A fifth embodiment of this invention is similar to one of the first, second, third, and fourth embodiments thereof except for design changes mentioned hereafter.

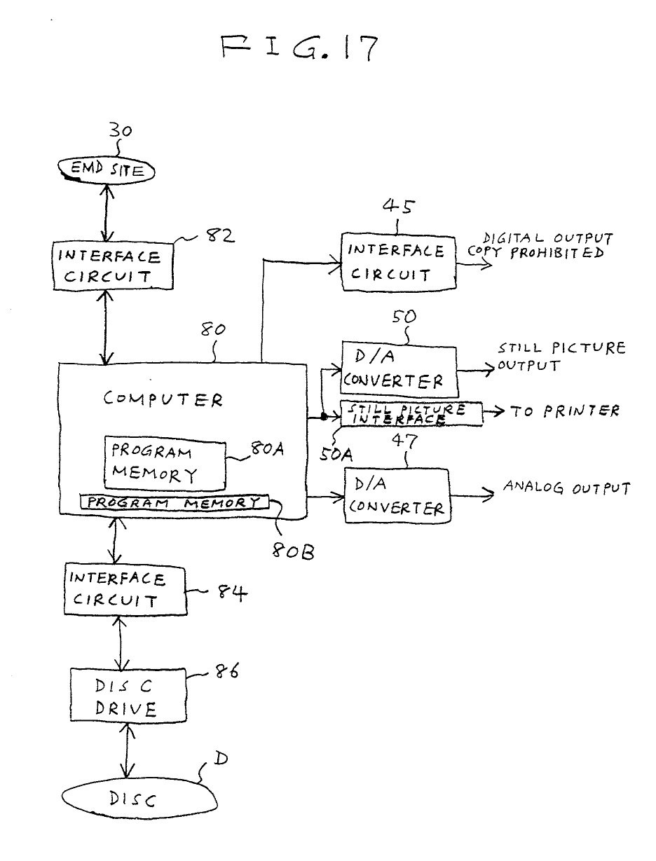

FIG. 14 shows an apparatus for recording and reproducing the DVD-AR contents 10 and the EMD contents 20 on and from the DVD-AR disc “D” according to the fifth embodiment of this invention. The recording and reproducing apparatus of FIG. 14 includes a computer 80. The computer 80 has a memory 80A loaded with a control program. The computer 80 operates in accordance with the control program.

The computer 80 is connected with the interface circuit 45, the D/A converter 47, the D/A converter 50, and the still-picture interface circuit 50A. Also, the computer 80 is coupled with interface circuits 82 and 84. The interface circuit 82 can be connected with the EMD system site 30 via the communication network such as the Internet. The interface circuit 84 is connected with a disc drive 86. The disc drive 86 can access the DVD-AR disc “D”. The computer 80 can control the interface circuits 82 and 84. The computer 80 can control the disc drive 86 via the interface circuit 84. The computer 80 may control the interface circuit 45 and the still-picture interface circuit 50A.

The recording and reproducing apparatus of FIG. 14 operates in either a recording mode or a reproducing mode. The recording mode of operation of the apparatus of FIG. 14 is as follows. The interface circuit 82 receives the EMD contents 20 from the EMD system site 30 while being controlled by the computer 80. The interface circuit 82 feeds the received EMD contents 20 to the computer 80 while being controlled thereby. According to the control program, the computer 80 decrypts the EMD contents 20 into non-encrypted EMD contents. The computer 80 demultiplexes or separates the non-encrypted EMD contents into the EMD added data 21, the EMD usage-rule information 22, and the EMD elementary stream 23.

According to the control program, the computer 80 decodes the EMD elementary stream 23 into linear PCM audio data (LPCM audio data). The computer 80 encodes the LPCM audio data into a temporary elementary stream of audio data of a prescribed form other than the LPCM form. The computer 80 selects either the LPCM audio data or the temporary elementary stream.

According to the control program, the computer 80 generates the DVD-AR navigation information 11 in response to the EMD added data 21. The computer 80 converts the EMD usage-rule information 22 into the DVD-AR usage-rule information 12. According to the control program, the computer 80 multiplexes or combines the EMD added data 21, the EMD usage-rule information 22, and the EMD elementary stream 23 into an EMD-contents signal of a prescribed DVD-AR format. The computer packets the selected LPCM audio data or the selected temporary elementary stream into DVD-AR audio objects (AOBs) 13. The computer 80 multiplexes or combines the DVD-AR navigation information 11, the DVD-AR rule-usage information 12, and the DVD-AR audio objects 13 into a DVD-AR-contents signal of the prescribed DVD-AR format. The computer 80 forms a sequence of the EMD-contents signal and the DVD-AR-contents signal.

According to the control program, the computer 80 encrypts at least a portion of the sequence of the EMD-contents signal and the DVD-AR-contents signal into an encryption-resultant signal. The computer 80 outputs the encryption-resultant signal to the interface circuit 84. The interface circuit 84 passes the encryption-resultant signal to the disc drive 86. The disc drive 86 records the encryption-resultant signal on the DVD-AR disc “D” while being controlled by the computer 80.

The reproducing mode of operation of the apparatus of FIG. 14 is as follows. The disc drive 86 is controlled by the computer 80, and hence reads out the encryption-resultant signal from the DVD-AR disc “D” which includes the DVD-AR contents 10. The disc drive outputs the read-out encryption-resultant signal to the interface circuit 84. The interface circuit 84 passes the read-out encryption-resultant signal to the computer 80.

According to the control program, the computer 80 decrypts the read-out encryption-resultant signal into the DVD-AR-contents signal. The computer 80 demultiplexes or separates the DVD-AR-contents signal into the DVD-AR navigation information 11, the DVD-AR rule-usage information 12, and the DVD-AR audio objects 13. The computer 80 de-packets the DVD-AR audio objects 13 into the LPCM audio data or the temporary elementary stream. When the temporary elementary stream is available, the computer 80 expansively decodes the temporary elementary stream into the LPCM audio data.

Preferably, the computer 80 controls the disc drive 86 to first reproduce the DVD-AR navigation information 11 from the DVD-AR disc “D”. Then, the computer 80 controls the disc drive 86 to reproduce the DVD-AR audio objects 13 from the DVD-AR disc “D” in accordance with the DVD-AR navigation information 11. Thus, the computer 80 implements the playback of the DVD-AR audio objects 13 according to the DVD-AR navigation information 11.

According to the control program, the computer 80 decides whether the playback of the DVD-AR contents 10 is permitted or prohibited on the basis of the DVD-AR usage-rule information 12. When it is decided that the playback of the DVD-AR contents 10 is permitted, the computer 80 outputs the LPCM audio data to the D/A converter 47. When it is decided that the playback of the DVD-AR contents 10 is prohibited, the computer 80 does not output the LPCM audio data to the D/A converter 47. The D/A converter 47 changes the LPCM audio data into the analog audio signal. The D/A converter 47 outputs the analog audio signal.

When it is decided that the playback of the DVD-AR contents is permitted, the computer 80 generates copy control information (copy management information) in response to the DVD-AR rule-usage information 12. The computer 80 adds the copy control information to the LPCM audio data or the temporary elementary stream to generate addition-resultant audio data. The computer 80 outputs the addition-resultant audio data to the interface circuit 45. When it is decided that the playback of the DVD-AR contents 10 is prohibited, the computer 80 fails to transmit the LPCM audio data or the temporary elementary stream to the interface circuit 45. The interface circuit 45 converts the addition-resultant audio data into the digital audio signal. The interface circuit 45 outputs the digital audio signal.

The read-out encryption-resultant signal outputted from the disc drive 86 may include the EMD-contents signal. In this case, the computer 80 decrypts the read-out encryption-resultant signal into the EMD-contents signal. The computer 80 demultiplexes or separates the EMD-contents signal into the EMD added data 21, the EMD usage-rule information 22, and the EMD elementary stream 23. The computer 80 implements SDMI checkout and check-in control of the EMD elementary stream 23 in response to the EMD usage-rule information 22.

As in the second embodiment of this invention, the directly recording of the EMD elementary stream 23 on the DVD-AR disc “D” may not be implemented.

The computer 80 may packet the EMD elementary stream 23 into EMD audio objects (AOBs) 24 as in the third embodiment of this invention. In this case, the EMD audio objects 24 are transmitted from the computer 80 to the disc drive 86 via the interface circuit 84 before being recorded on the DVD-AR disc “D” by the disc drive 86.

The computer 80 may extract the still-picture data 25 from the EMD added data 21 as in the fourth embodiment of this invention. In this case, the computer 80 encrypts the extracted still-picture data 25. The encryption-resultant still-picture data 25 are transmitted from the computer 80 to the disc drive 86 via the interface circuit 84 before being recorded on the DVD-AR disc “D” by the disc drive 86.

The still-picture data 25 are reproduced as follows. The disc drive 86 reads out the encryption-resultant signal therefrom while being controlled by the computer 80. The disc drive 86 outputs the read-out encryption-resultant signal to the interface circuit 84. The interface circuit 84 passes the read-out encryption-resultant signal to the computer 80. According to the control program, the computer 80 decrypts the read-out encryption-resultant signal to get a decryption-resultant signal. The computer 80 demultiplexes or separates the decryption-resultant signal into the DVD-AR navigation information 11, the DVD-AR rule-usage information 12, the LPCM audio data or the temporary elementary stream, and the still-picture data 25. The computer 80 decodes every 1-frame-corresponding portion of the still-picture data 25 into a 1-frame-corresponding digital still-picture signal. The computer 80 outputs the 1-frame-corresponding digital still-picture signal to the D/A converter 50. The D/A converter 50 changes the 1-frame-corresponding digital still-picture signal into the corresponding analog signal of the NTSC or PAL television format which indicates a 1-frame still picture. The D/A converter 50 outputs the analog still-picture signal.

According to the control program, the computer 80 outputs the digital still-picture signal to the still-picture interface circuit 50A. The still-picture interface circuit 50A converts the format of the output signal of the computer 80 into a format suited for transmission to a printer (not shown), for example, a format conforming to the USB standards. The still-picture interface circuit 50A is connected with the printer on a wireless or wired basis. A signal representative of “copy prohibited” may be contained in a still-picture signal directed to the printer. The computer 80 or the still-picture interface circuit 50A may execute the addition of a “copy prohibited” signal into a still-picture signal directed to the printer. The still-picture interface 50A may respond to the “copy prohibited” signal under the control by the computer 80. Specifically, in the presence of a “copy prohibited” signal in a still-picture signal directed to the printer, the still-picture interface circuit 50A prohibits the transmission of the still-picture signal to the printer. In the absence of a “copy prohibited” signal from a still-picture signal directed to the printer, the still-picture interface circuit 50A permits and executes the transmission of the still-picture signal to the printer.

As previously mentioned, the computer 80 operates in accordance with the control program. FIG. 15 shows a segment of the control program which relates to the recording mode of operation of the apparatus of FIG. 14. With reference to FIG. 15, a first step S11 of the program segment generates the DVD-AR audio objects 13 by packeting the selected LPCM audio data or the selected temporary elementary stream. A step S12 following the step S11 generates the DVD-AR navigation information (the playback management data) 11. A step S13 subsequent to the step S12 multiplexes or combines the EMD added data 21, the EMD usage-rule information 22, and the EMD elementary stream 23 into the EMD-contents signal of the prescribed DVD-AR format. The step S13 multiplexes or combines the DVD-AR navigation information 11, the DVD-AR rule-usage information 12, and the DVD-AR audio objects 13 into the DVD-AR-contents signal of the prescribed DVD-AR format. The step S13 controls the disc drive 86, thereby recording the EMD-contents signal and the DVD-AR-contents signal on the DVD-AR disc “D”. After the step S13, the current execution cycle of the program segment ends.

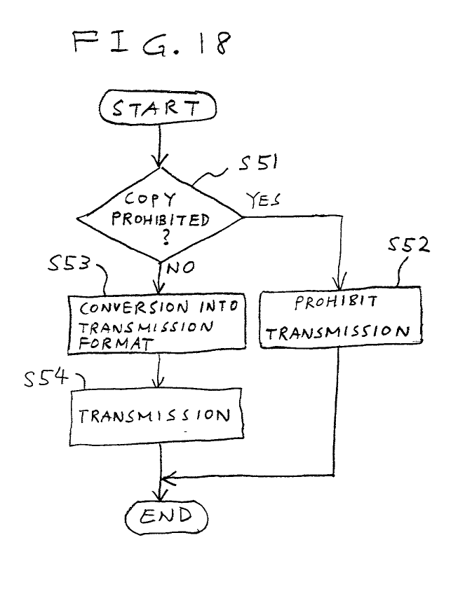

FIG. 16 shows a segment of the control program which relates to the reproducing mode of operation of the apparatus of FIG. 14.

With reference to FIG. 16, a first step S21 of the program segment controls the disc drive 86, thereby reading out the DVD-AR navigation information (the playback management data) 11 from the DVD-AR disc “D”. A step S22 following the step S21 controls the disc drive 86, thereby reading out the DVD-AR audio objects 13 from the DVD-AR disc “D” in response to the DVD-AR navigation information 11. A step S23 subsequent to the step S22 de-packets the DVD-AR audio objects 13 into the LPCM audio data or the temporary elementary stream to implement the playback or reproduction of the audio information in accordance with the DVD-AR navigation information 11. After the step S23, the current execution cycle of the program segment ends.

### Sixth Embodiment

FIG. 17 shows an apparatus according to a sixth embodiment of this invention. The apparatus of FIG. 17 is similar to the apparatus of FIG. 14 except for additional designs mentioned later. The apparatus of FIG. 17 can transmit contents information to the EMD system site 30. The apparatus of FIG. 17 can control the transmission of the contents information to the EMD system site 30 in response to copy control information within the contents information. The apparatus of FIG. 17 can receive contents information from the EMD system site 30. The apparatus of FIG. 17 can implement mutual authentication with the EMS system site 30. The apparatus of FIG. 17 can control the reception of the contents information from the EMD system site 30 in response to the result of the mutual authentication.

The apparatus of FIG. 17 can receive contents information representative of a computer program from the EMD system site 30. The received computer program may be the same as the control program segment used in the apparatus of FIG. 14 which relates to the recording mode of operation thereof. The received computer program may be the same as the control program segment used in the apparatus of FIG. 14 which relates to the reproducing mode of operation thereof. The apparatus of FIG. 17 can transmit contents information representative of a computer program to the EMD system site 30. The transmitted computer program may be the same as the control program segment used in the apparatus of FIG. which relates to the recording mode of operation thereof. The transmitted computer program may be the same as the control program segment used in the apparatus of FIG. 14 which relates to the reproducing mode of operation thereof.

The apparatus of FIG. 17 includes a computer 80. The computer 80 has a first memory 80A and a second memory 80B. The second memory 80B is loaded with a first control program. The first memory 80A may be loaded with a second control program. The computer 80 operates in accordance with either the first control program or the second control program.

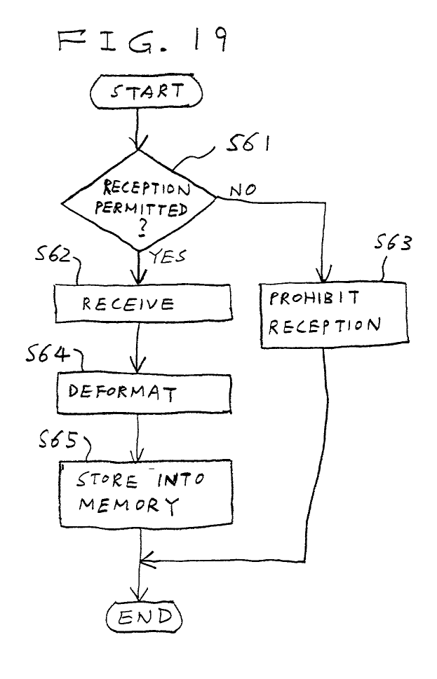

The apparatus of FIG. 17 operates in a mode which can be selected from plural modes including a transmitting mode and a receiving mode. FIG. 18 shows a segment of the first control program which relates to the transmitting mode of operation of the apparatus of FIG. 17. With reference to FIG. 18, a first step S51 of the program segment checks copy control information in contents data to be transmitted. Basically, the contents data are audio data or still-picture-added audio data. Alternatively, the contents data may represent the second control program. The step S51 decides whether or not the copy control information is in a state of “copy prohibited”. When the copy control information is in the state of “copy prohibited”, the program advances from the step S51 to a step S52. Otherwise, the program advances from the step S51 to a step S53. The step S52 inhibits the transmission of the contents data toward the EMD system site 30. After the step S52, the current execution cycle of the program segment ends. The step S53 arranges the contents data into a packet-based format for transmission. A step S54 following the step S53 outputs the packet-format contents data to the interface circuit 82. The step S54 controls the interface circuit 82 to transmit the packet-format contents data toward the EMD system site 30. After the step S54, the current execution cycle of the program segment ends.

In the case where the contents data represent the second control program, the step S51 also decides whether or not accounting conditions are satisfied. When the accounting conditions are satisfied, the program advances from the step S51 to the step S53. Otherwise, the program advances from the step S51 to the step S52.

FIG. 19 shows a segment of the first control program which relates to the receiving mode of operation of the apparatus of FIG. 17. With reference to FIG. 19, a first step S61 of the program segment controls the interface circuit 82, and communicates with the EMD system site 30 via the interface circuit 82. Specifically, the step S61 implements mutual authentication with the EMD system site 30. By referring to the result of the mutual authentication, the step S61 decides whether or not the present apparatus is legitimate to the EMD system site 30. When the present apparatus is legitimate to the EMD system site 30, the step S61 determines that reception should be permitted. Otherwise, the step S61 determines that reception should not be permitted. When the present apparatus is legitimate to the EMD system site 30, that is, when reception should be permitted, the program advances from the step S61 to a step S62. Otherwise, the program advances from the step S61 to a step S63. The step S63 controls the interface circuit 82 to prohibit reception of packet-format contents data from the EMD system site 30. After the step S63, the current execution cycle of the program segment ends. On the other hand, the step S62 controls the interface circuit 82, and receives packet-format contents data from the EMD system site 30 via the interface circuit 82. A step S64 following the step S62 deformats or de-packets the received packet-format contents data into original contents data in response to packet headers in the received packet-format contents data. A step S65 subsequent to the step S64 stores the original contents data into a memory within the computer 80. Basically, the contents data are audio data or still-picture-added audio data. Alternatively, the contents data may represent a second control program. In the case where the contents data represent the second control program, the step S65 stores the contents data into the first memory 80A. After the step S65, the current execution cycle of the program segment ends.

In the case where the contents data represent the second control program, the step S61 also decides whether or not accounting conditions are satisfied. When the accounting conditions are satisfied, the program advances from the step S61 to the step S62. Otherwise, the program advances from the step S61 to the step S63.

What is claimed is:

1. An audio-information recording medium having a data structure including:
a first elementary stream resulting from encoding audio data;
first digital right information about the audio data;
added data related to the audio data;
audio objects resulting from packeting one of (1) linear PCM audio data being expansion of the first elementary stream and (2) a second elementary stream being compression of the linear PCM audio data;
second digital right information related to the audio objects and generated on the basis of the first digital right information; and
playback management data related to the audio objects and generated on the basis of the added data.

2. An audio-information recording medium as recited in claim 1, wherein the first elementary stream and the audio objects are encrypted.

3. An audio-information recording medium as recited in claim 1, wherein the first elementary stream and the audio objects are in a same file.

4. An audio-information recording medium having a data structure including:
audio objects resulting from packeting a first elementary stream being compression of audio data;
first digital right information about the audio data;
added data related to the audio data;
second digital right information related to the audio objects and generated on the basis of the first digital right information; and
playback management data related to the audio objects and generated on the basis of the added data.

5. A recording apparatus comprising:
first means for recording a first elementary stream, first digital right information, and added data on a recording medium, the first elementary stream resulting from encoding audio data, the first digital right information being about the audio data, the added data being related to the audio data;
second means for expanding the first elementary stream into linear PCM audio data;
third means for compressing the linear PCM audio data into a second elementary stream;
fourth means for packeting one of (1) the linear PCM audio data and (2) the second elementary stream into audio objects;
fifth means for generating second digital right information on the basis of the first digital right information, the second digital right information being related to the audio objects;
sixth means for generating playback management data on the basis of the added data, the playback management data being related to the audio objects; and
seventh means for recording the audio objects, the second digital right information, and the playback management data on the recording medium.

6. A recording apparatus comprising:
first means for packeting a first elementary stream into audio objects, the first elementary stream being compression of audio data;
second means for generating, on the basis of first digital right information about the audio data, second digital right information related to the audio objects;
third means for generating playback management data on the basis of added data, the playback management data being related to the audio objects, the added data being related to the audio data; and
fourth means for recording the first digital right information, the added data, the audio objects, the second digital right information, and the playback management data on a recording medium.

7. A recording apparatus as recited in claim 5, further comprising means for receiving the first elementary stream, the first digital right information, and the added data from an electronic music distribution system.

8. A computer program comprising the steps of:
recording a first elementary stream, first digital right information, and added data on a recording medium, the first elementary stream resulting from encoding audio data, the first digital right information being about the audio data, the added data being related to the audio data;
expanding the first elementary stream into linear PCM audio data;
compressing the linear PCM audio data into a second elementary stream;
packeting one of (1) the linear PCM audio data and (2) the second elementary stream into audio objects;
generating second digital right information on the basis of the first digital right information, the second digital right information being related to the audio objects;
generating playback management data on the basis of the added data, the playback management data being related to the audio objects; and
recording the audio objects, the second digital right information, and the playback management data on the recording medium.

9. A computer program comprising the steps of:
packeting a first elementary stream into audio objects, the first elementary stream being compression of audio data;
generating, on the basis of first digital right information about the audio data, second digital right information related to the audio objects;
generating playback management data on the basis of added data, the playback management data being related to the audio objects, the added data being related to the audio data; and
recording the first digital right information, the added data, the audio objects, the second digital right information, and the playback management data on a recording medium.

10. A computer program as recited in claim 8, further comprising the step of receiving the first elementary stream, the first digital right information, and the added data from an electronic music distribution system.

11. A reproducing apparatus comprising:
first means for reading out the second digital right information and the playback management data from the audio-information recording medium of claim 1; and
second means for reproducing the audio objects from the audio-information recording medium and playing back the audio objects in accordance with the second digital right information and the playback management data read out by the first means.

12. A computer program comprising the steps of:
reading out the second digital right information and the playback management data from the audio-information recording medium of claim. 1; and
reproducing the audio objects from the audio-information recording medium and playing back the audio objects in accordance with the read-out second digital right information and the read-out playback management data.

13. An audio-information recording medium having a data structure including:
first audio objects resulting from packeting a first elementary stream being compression of audio data;
second audio objects resulting from packeting one of (1) linear PCM audio data being expansion of the first elementary stream and (2) a second elementary stream being compression of the linear PCM audio data;
first digital right information for control of the first and second audio objects, the first digital right information being generated on the basis of second digital right information about the audio data; and
playback management data related to the first and second audio objects and generated on the basis of added data related to the audio data.

14. An audio-information recording medium as recited in claim 1, wherein the data structure further includes one of (1) still-picture data being third elementary streams representative of one or more still pictures and (2) still-picture objects resulting from packeting the third elementary stream, the third elementary stream being contained in the added data.

15. A recording apparatus comprising:
first means for packeting a first elementary stream into first audio objects, the first elementary stream being compression of audio data;
second means for expanding the first elementary stream into linear PCM audio data;
third means for compressing the linear PCM audio data into a second elementary stream;
fourth means for packeting one of (1) the linear PCM audio data and (2) the second elementary stream into second audio objects;
fifth means for generating, on the basis of first digital right information about the audio data, second digital right information related to the first and second audio objects;
sixth means for generating playback management data on the basis of added data, the playback management data being related to the first and second audio objects, the added data being related to the audio data; and
seventh means for recording the first and second audio objects, the second digital right information, and the playback management data on a recording medium.

16. A recording apparatus as recited in claim 15, further comprising:
eighth means for extracting a third elementary stream representative of a still picture from the added data to generate still-picture data;
ninth means for packeting the third elementary stream into still-picture objects; and
tenth means for recording one of (1) the still-picture data and (2) the still-picture objects on the recording medium.

17. A recording apparatus as recited in claim 16, further comprising means for receiving the first elementary stream, the first digital right information, and the added data from an electronic music distribution system.

18. A computer program comprising the steps of:
packeting a first elementary stream into first audio objects, the first elementary stream being compression of audio data;
expanding the first elementary stream into linear PCM audio data;
compressing the linear PCM audio data into a second elementary stream;
packeting one of (1) the linear PCM audio data and (2) the second elementary stream into second audio objects;
generating, on the basis of first digital right information about the audio data, second digital right information related to the first and second audio objects;
generating playback management data on the basis of added data, the playback management data being related to the first and second audio objects, the added data being related to the audio data; and
recording the first and second audio objects, the second digital right information, and the playback management data on a recording medium.

19. A computer program as recited in claim 18, further comprising the steps of:
extracting a third elementary stream representative of a still picture from the added data to generate still-picture data;
packeting the third elementary stream into still-picture objects; and
recording one of (1) the still-picture data and (2) the still-picture objects on the recording medium.

20. A computer program as recited in claim 19, further comprising the step of receiving the first elementary stream, the first digital right information, and the added data from an electronic music distribution system.

21. A reproducing apparatus comprising:
first means for reading out the first digital right information and the playback management data from the audio-information recording medium of claim 13; and
second means for reproducing the second audio objects from the audio-information recording medium and playing back the second audio objects in accordance with the first digital right information and the playback management data read out by the first means.

22. A computer program comprising the steps of:
reading out the first digital right information and the playback management data from the audio-information recording medium of claim 13; and
reproducing the second audio objects from the audio-information recording medium and playing back the second audio objects in accordance with the read-out first digital right information and the read-out playback management data.

23. A recording and reproducing apparatus comprising the recording apparatus of claim 5 and the reproducing apparatus of claim 11.

24. A method of transmitting or receiving a computer program comprising the steps of.
recording a first elementary stream, first digital right information, and added data on a recording medium, the first elementary stream resulting from encoding audio data, the first digital right information being about the audio data, the added data being related to the audio data;
expanding the first elementary stream into linear PCM audio data;
compressing the linear PCM audio data into a second elementary stream;
packeting one of (1) the linear PCM audio data and (2) the second elementary stream into audio objects;
generating second digital right information on the basis of the first digital right information, the second digital right information being related to the audio objects;
generating playback management data on the basis of the added data, the playback management data being related to the audio objects; and
recording the audio objects, the second digital right information, and the playback management data on the recording medium.

25. A method of transmitting or receiving a computer program comprising the steps of:
reading out the second digital right information and the playback management data from the audio-information recording medium of claim 1; and
reproducing the audio objects from the audio-information recording medium and playing back the audio objects in accordance with the read-out second digital right information and the read-out playback management data.

26. A reproducing apparatus comprising first means for reproducing information from a recording medium and second means for decoding a signal in the reproduced information which represents at least one still picture, wherein the information has been recorded on the recording medium by a method comprising the steps of:
recording a first elementary stream, first digital right information, and added data on a recording medium, the first elementary stream resulting from encoding audio data, the first digital right information being about the audio data, the added data being related to the audio data;
expanding the first elementary stream into linear PCM audio data;
compressing the linear PCM audio data into a second elementary stream;
packeting one of (1) the linear PCM audio data and (2) the second elementary stream into audio objects;
generating second digital right information on the basis of the first digital right information, the second digital right information being related to the audio objects;
generating playback management data on the basis of the added data, the playback management data being related to the audio objects; and
recording the audio objects, the second digital right information, and the playback management data on the recording medium.

27. A reproducing apparatus as recited in claim 26, further comprising a printer interface for transmission of at least a still-picture-representing portion of the reproduced information.

28. A method of transmitting or receiving data recorded according to a computer program comprising the steps of:
recording a first elementary stream, first digital right information, and added data on a recording medium, the first elementary stream resulting from encoding audio data, the first digital right information being about the audio data, the added data being related to the audio data;
expanding the first elementary stream into linear PCM audio data;
compressing the linear PCM audio data into a second elementary stream;
packeting one of (1) the linear PCM audio data and (2) the second elementary stream into audio objects;
generating second digital right information on the basis of the first digital right information, the second digital right information being related to the audio objects;
generating playback management data on the basis of the added data, the playback management data being related to the audio objects; and
recording the audio objects, the second digital right information, and the playback management data on the recording medium.

29. A method of transmitting or receiving data reproduced according to a computer program comprising the steps of:
reading out the second digital right information and the playback management data from the audio-information recording medium of claim 1; and
reproducing the audio objects from the audio-information recording medium and playing back the audio objects in accordance with the read-out second digital right information and the read-out playback management data.
